(19) United States
(12) Patent Application Publication
(10) Pub. No.: US 2024/0367589 A1
(43) Pub. Date: Nov. 7, 2024

(54) Headrest Storage Pocket

(71) Applicant: Irvin Automotive Products, LLC, Pontiac, MI (US)

(72) Inventors: Michael Joseph Gregg, Rochester Hills, MI (US); Nicholas Ryan Woodhull, Orion, MI (US); Gregory Lee Ward, Wolverine Lake, MI (US); Bryan Wesley Busha, Grand Blanc, MI (US)

(73) Assignee: Irvin Automotive Products, LLC, Pontiac, MI (US)

(21) Appl. No.: 18/143,294

(22) Filed: May 4, 2023

(51) Int. Cl. B60R 7/00; B60N 2/879

(52) U.S. Cl. CPC B60R 7/005; B60N 2/879

(57) ABSTRACT

A headrest storage pocket for use in a vehicle headrest seat is disclosed. The headrest storage pocket for use in a vehicle seat comprises a pocket made of a webbing, wherein that pocket is attached to a rear surface of the headrest of the vehicle seat. The headrest storage pocket also comprises an elastic band attached to a top edge of the pocket, wherein the pocket having a first side edge, a second side edge and a bottom edge. The first side edge, second side edge and bottom edge are secured to the rear surface of the headrest via at least one sewn seam. The headrest storage pocket may allow for storage of objects in the back rear surface of the vehicle headrest thus preventing the objects from being thrown around the interior compartment of the vehicle during driving thereof and keeping the objects in an easy to reach area of the vehicle.

### BACKGROUND OF THE INVENTION

### 1. Field of the Invention

The present invention generally relates to vehicle seats and more particularly relates to a headrest for use on a vehicle.

### 2. Description of Related Art

Vehicle seats have been well known in the art for numerous years. Vehicle seats are used to hold occupants in predetermined positions within the interior cabin of a vehicle. The vehicle seats generally include a headrest, which are adjustable to conform to the height of the user of the vehicle seat. The headrests have the requisite padding to help avoid injury during vehicle collisions and the like. The vehicle headrests generally have a frame with the associated padding arranged thereover and a vehicle seat cover material arranged on the outside of the vehicle headrest. The vehicle headrest may also include at least one, but in most embodiments, two connecting rods extending from the bottom thereof, wherein those connecting rods are inserted into two orifices of the seat back of the vehicle seat. As noted above, the vehicle headrest generally is adjustable in a vertical direction and in a horizontal direction in many modern day vehicles. The vehicle headrest of the present day also may include video screens attached to a rear surface of the headrest to allow for the watching of videos, TV, the Internet and other visual medium to passengers in the rear seats of the vehicle. However, some vehicle headrests in the prior art include storage areas arranged therein. In one prior art headrest, a door pivots in a rear portion of the headrest to allow for storage within the frame of the headrest.

Therefore, there is a need in the art for a headrest storage pocket, which is attached to a rear portion of a vehicle headrest. There also is a need in the art for a headrest storage pocket that uses a combination of webbing and elastic to allow for storage of multiple items including cell phones and the like in the back of the headrest for vehicle occupants in the rear seats of vehicles. There also is a need in the art for a headrest storage pocket that includes a flap that has a stiffener arranged therein, thus creating a pocket between the flap and the back rear surface of the vehicle headrest. These pockets may allow for multiple items to be stored in the vehicle headrest. The storage of items in the vehicle headrest on the rear portion thereof may allow for quick and easy access to the objects stored by the vehicle occupants in the rear seats of the vehicle headrest. There also is a need in the art for an economical to manufacture storage area on the back or rear surface of a vehicle headrest.

### SUMMARY OF THE INVENTION

One object of the present invention may be to provide an improved headrest.

Another object of the present invention may be to provide a headrest that has a headrest storage pocket arranged on a rear surface thereof.

Yet a further object of the present invention may be to provide a headrest storage pocket that uses a webbing or netting type pocket that is sewn into the headrest cover on a rear surface thereof.

Still a further object of the present invention may be to provide a headrest storage pocket that uses a flap with a stiffener that may include bands or cords that are sewn between the flap and the rear of the headrest cover.

Still another object of the present invention may be to provide a headrest storage pocket in the rear portion of a headrest that uses a hard trim pocket that has netting arranged within the hard trim pocket, which is connected via fasteners to a rear surface of a vehicle headrest.

Another object of the present invention may be to provide a webbing pocket that has an elastic band arranged at a top end thereof for securely holding items within the web pocket on the rear surface of the vehicle headrest.

According to the present invention, the foregoing and other objects and advantages are obtained by a novel headrest storage pocket for use on a vehicle seat headrest. The headrest storage pocket for use on a vehicle seat comprises a pocket made of webbing, wherein that pocket is attached to a rear surface of a headrest of the vehicle seat and an elastic band is attached to a top edge of the pocket. The webbing pocket, having a first edge, a second edge and a bottom edge, wherein the first edge, second edge and bottom edge are secured to the rear surface of the headrest via at least one joining seam. The top edge of the pocket is free to move with respect to the rear surface of the vehicle headrest to allow for storage of items within the webbed pocket, wherein the elastic band is used to help secure the items within the pocket during movement of the vehicle.

One advantage of the present invention may be that it provides for an improved vehicle headrest.

A further advantage of the present invention may be that it provides for an improved vehicle headrest that has a headrest storage pocket arranged on a rear surface thereof.

A further advantage of the present invention may be that it provides for a headrest storage pocket for use on a vehicle headrest, wherein the storage pocket is made of a webbing material that has an elastic band arranged at a top edge of the webbing, the storage pocket is connected to a rear surface of the vehicle headrest.

Still another advantage of the present invention may be that it provides for a headrest storage pocket for use on a vehicle seat, wherein a hard trim predetermined shaped member or frame is attached to a rear surface of the headrest and a webbing pocket is arranged within the hard trim frame allowing for storage of various items, such as cell phones, in the headrest storage pocket arranged on a rear surface of the headrest.

Still another advantage of the present invention may be to provide a vehicle storage headrest that includes a flap having a stiffener arranged therein secured at a bottom edge thereof to a rear surface of the vehicle headrest.

Yet another advantage of the present invention may be to provide a headrest storage pocket for use in a vehicle seat headrest that includes a cord arranged between a flap and a rear surface of the headrest in order to allow for the flap to be moved away from the rear surface of the vehicle headrest in order to store items within the pocket formed by the flap in the vehicle headrest rear surface.

Yet another advantage of the present invention may be to provide an easy to manufacture and economical vehicle headrest storage pocket for use on a rear surface of the vehicle headrest.

Other objects, features and advantages of the present invention may become apparent from the subsequent description and appended claims, taken in conjunction with the accompanying drawings.

### BRIEF DESCRIPTION OF THE DRAWINGS

FIG. 1 shows a vehicle headrest having the headrest storage pocket arranged thereon attached to a vehicle seat according to the present invention.

FIG. 2 shows an alternate embodiment of the vehicle headrest storage pocket attached to a vehicle seat according to the present invention.

FIG. 3 shows a partial cross sectional view of a headrest storage pocket according to the present invention.

FIG. 4 shows an alternate embodiment of the headrest storage pocket in partial cross section according to the present invention.

FIG. 5 shows an alternate embodiment of a vehicle headrest having the headrest storage pocket according to the present invention.

FIG. 6 shows a plan view of a vehicle headrest storage pocket arranged on a rear surface of a vehicle headrest according to the present invention.

FIG. 7 shows a plan view of an alternate embodiment of a vehicle headrest storage pocket according to the present invention.

FIG. 8 shows a cross sectional view of an alternate embodiment of the headrest storage pocket of FIG. 7.

FIG. 9 shows a close up view of a headrest storage pocket of FIG. 8.

FIG. 10 shows an alternate embodiment of a headrest storage pocket according to the present invention.

FIG. 11 shows a partially exploded view of the vehicle headrest storage pocket of FIG. 10.

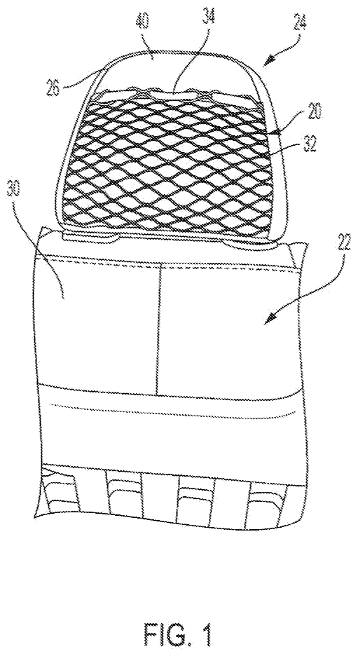

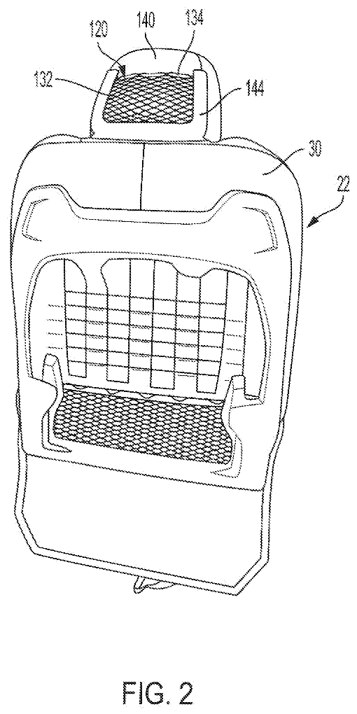

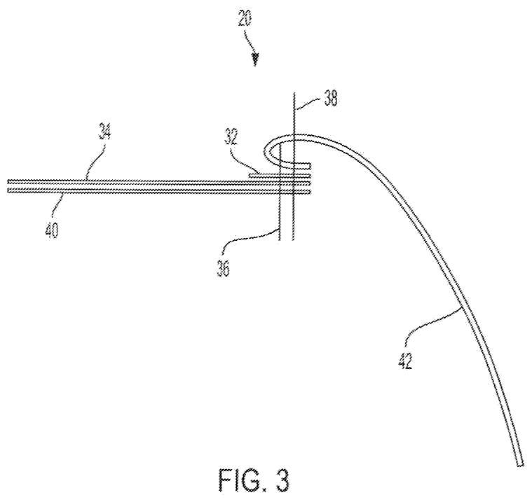

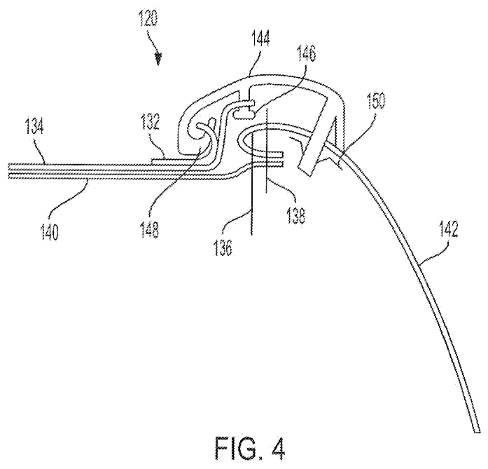

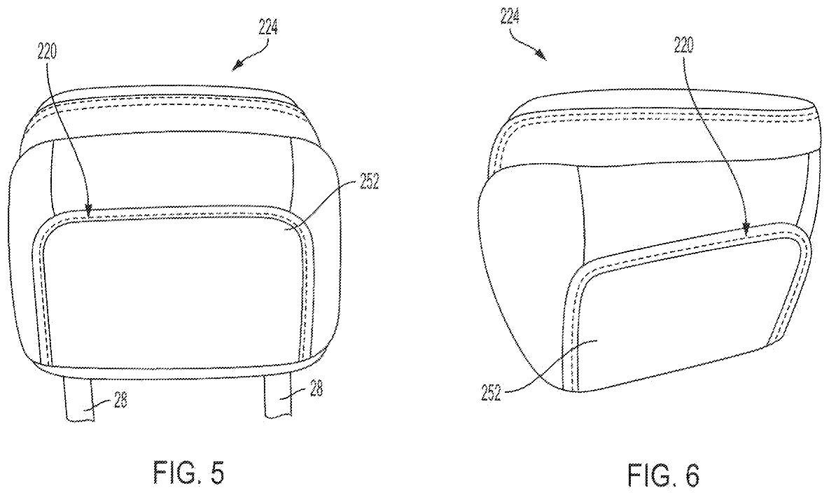

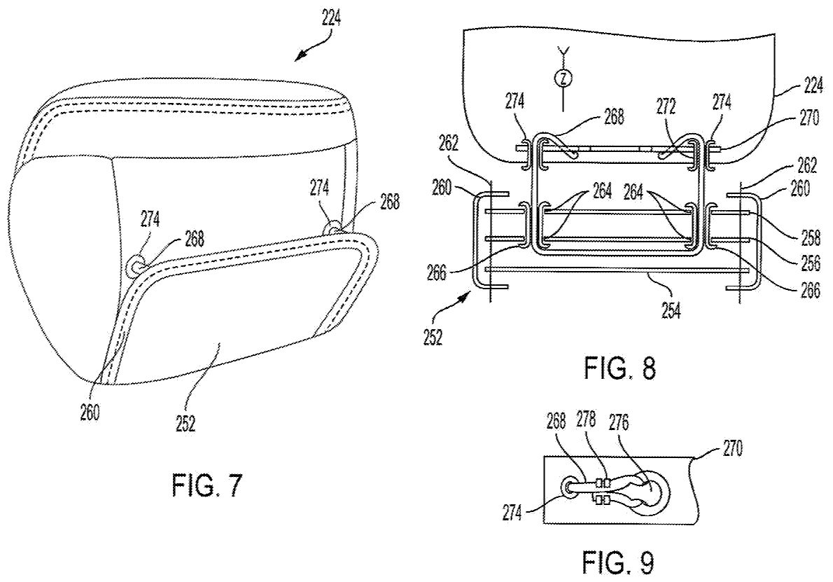

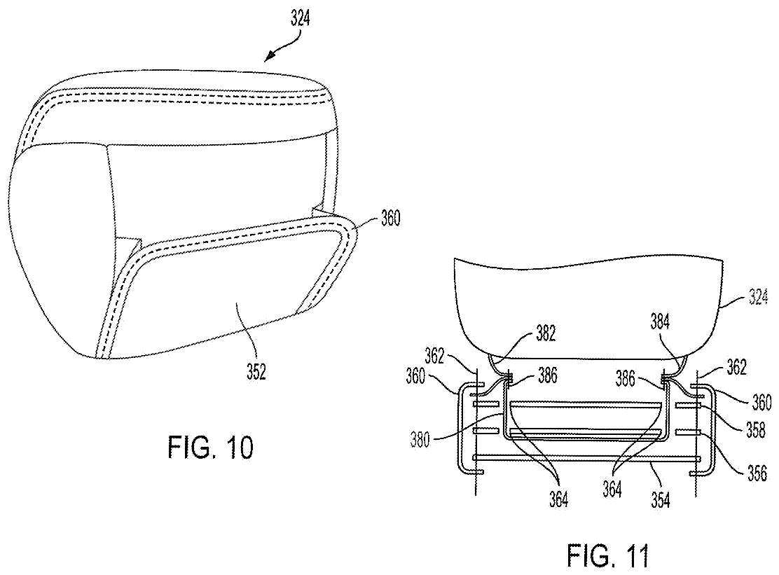

### BRIEF DESCRIPTION OF THE EMBODIMENT(S)

Referring to the drawings, there is shown a headrest storage pocket 20 for use on a vehicle seat 22 according to the present invention. It should be noted that the vehicle headrest 24 as shown in the drawings is for use in an automotive vehicle, however the headrest storage pocket 20 may be used on any headrest 24 known and for use on any known vehicle, such as but not limited to automotive, aeronautical, space, marine, or any other type of vehicle that has a vehicle seat 22 that includes a headrest 24 attached thereto. The headrest storage pocket 20 may also be used on seats that are not used in a vehicle, such as but not limited to recliner chairs, office chairs, or the like. Therefore, it should be noted that the headrest storage pocket 20 of the present invention may be used on any known headrest on any know seat. The headrest 24 may have any known shape, such as a rectangular shape, square shape, circle shape, oval shape, random shape, or any other known shape. Generally, the headrest storage pocket 20 of the present invention is attached to a rear surface of the headrest for use on a seat 22. It should be noted that the headrest 24 on most vehicle seats 22 are adjustable in a vertical direction and horizontal direction to accommodate various users sitting in the vehicle seat 22. The vehicle headrest 24 may generally include an internal frame and related components therein along with the necessary padding and a vehicle seat cover material 26 arranged over the padding in order to create an aesthetically pleasing and ergonomically useful vehicle headrest 24. The vehicle headrest 24 generally includes at least one, but in most instances, two connecting rods 28 extending from a bottom surface thereof, wherein the connecting rods 28 are inserted into predetermined shaped and located orifices on a vehicle seat back 30 top surface in order for the headrest 24 to be connected to the vehicle seatback 30 in proper position therewith. It should also be noted that the vehicle seats 22 also include a seat portion connected to the vehicle seat back 30, thus allowing for users to be comfortably seated within the vehicle during use thereof. It should be noted that any type of material may be used to cover the headrest 24, such as leather, vinyl, pleather, cloth, or any known material used on the outer surface of vehicle seats.

The headrest 24 of the present invention as shown in the drawings may include a soft trim sewn in storage webbing pocket or headrest storage pocket 20 arranged in a rear surface of the vehicle headrest 24. The headrest storage pocket 20 may be made of a webbing or netting type material 32, wherein a pocket may be formed from the webbing 32 wherein the pocket 26 mimics the shape of the back rear surface of the vehicle headrest 24. Hence, the shape of the pocket 20 may be any known shape depending on the shape of the vehicle headrest 24 other than the generally square or rectangular shapes shown in the drawings. The webbing pocket 20 has the appearance of a net, such that the webbing also includes a predetermined elastomeric co-efficient such that it may expand to allow for storage of numerous items within the webbed storage pocket 20 on the rear surface of the headrest 24. The webbing 32 also may include a band 34 arranged at the top end of the webbing pocket 20. In one contemplated embodiment, the band 34 is made of an elastic material and the band 34 is arranged through orifices of the netting 32 in an alternating braid like pattern. This may allow for the elastic band 34 to create a more secure closure for the top portion of the vehicle pocket 20 to the rear surface of the vehicle headrest 24. Generally, the pocket 20 is sewn directly into the rear surface seam of the vehicle headrest 24 on a first and second side edge and on the bottom edge of the webbed pocket 20. In one contemplated embodiment, the webbing 32 may be secured via a first 36 and second seam 38, such as a join seam and a deck seam for the rear surface cover material 40 of the vehicle headrest 24. This may ensure that two seams are being used to secure the three sides of the pocket 20 to the rear surface 40 of the vehicle headrest 24. Therefore, the pocket 20 may be connected via a sewn stitch along the bottom edge and the two side edges of the webbed pocket 20. Furthermore, the elastic band 34 may also be secured via the join seam 36 and deck seam 38 to a first side edge and a second side edge of the rear surface 40 of the vehicle headrest 24. As shown in the figures, the vehicle headrest cover material 26 has the elastic band 34 and netting 32 secured thereto along the join seam and the deck seam on the rear edge of the vehicle headrest 24. This may allow for storage of cell phones, cameras, pencils, small purses in the rear of the headrest 24 by passengers in the rear seat of vehicles according to the present invention.

As shown in the figures the join seam 36 and the deck 38 seam may connect the rear panel cover material 40 of the headrest 24 to the elastic band 34 and the webbing portion 32 and the side cover material 42 for the vehicle headrest 24. All four of these components may be sewn together at the join seam 36 and the deck seam 38 as shown in the figures. The vehicle headrest cover 26 would then be arranged over the vehicle headrest frame and padding to make a vehicle headrest 24. In one contemplated embodiment, the rear cover material 40 may be in contact with the first end of the elastic band 34 on a first side edge thereof and a second end of the elastic band 34 may be in contact with the second side edge of the rear cover material 40. It should further be noted that the elastic band 34 may only be sewn between the netting 32 and the rear cover material 40 and side cover material 42 at the top portion of the webbing pocket 20 while the other portions of the webbing pocket 20 only have the rear cover material 40 and side cover material 42 for the vehicle headrest 24 sandwiched around the webbing pocket 20 side edges and bottom edges. It should be noted that the top edge of the pocket 20 is a predetermined distance below the top edge of the headrest 24.

The figures also show an alternate embodiment for the vehicle headrest storage pocket 120 according to the present invention. Like numerals indicate like parts. In this contemplated embodiment, the webbing pocket portion 132 and band 134, being made of an elastic material, are the same as that described above for the previous embodiment. It should be noted that the band 134 of any embodiments disclosed herein may be made of any known material, not just elastic, including but not limited to metal, composite, rubber, soft plastic, hard plastics, man-made materials, natural materials or any other known material capable of having elastomeric properties therein and/or a spring force thereon. This embodiment also may include a generally U-shaped hard trim retaining or frame member 144 arranged around an outer periphery of a portion of the rear surface of the headrest 24. In one contemplated embodiment, the hard trim member 144 has a generally U-shape, however any known shape may be used for the hard trim member 144 depending on the shape of the vehicle headrest 24 to which the headrest storage pocket 120 may be used. Hence, if the headrest 24 has a rectangular shape, a square shape, or a circular shape, then the hard trim member 144 may have a shape that coincides with the bottom edge and a predetermined portion of the two side edges of the rear of the vehicle headrest 24. In one contemplated embodiment, the hard trim member 144 may be made of a hard plastic material, however it should be known that any other type of material including any composite, metal, soft plastic, natural material or man-made material may also be used for the hard trim member 144 according to the present invention.

The hard trim member 144 may have arranged from an inner surface thereof a heat stake 146. The heat stake 146 is generally arranged near or at a mid-point of the pocket frame 144. The heat stake 146 may be used to secure the band 134 to the inner surface of the frame 144 of the headrest storage pocket 120 according to the present invention. The headrest storage pocket 120 may also include a hook 148 arranged at or near one end on an inner surface of the frame 144. The hook 145 may be used to have at least one loop of the webbing/netting 132 arranged thereover in order to secure the webbing 132 to the frame 144 according to the present invention. It should further be noted that the frame member 144 may also include a retaining fastener 150 arranged at another end of the frame 144. The retainer fastener 150 generally may be used to be secure the frame 144 to the cover material 126 and headrest 124 of the present invention. Any known retaining fastener 150, such as a snap, hook and loop, push pin, etc., may be used to secure the frame member 144 to the rear surface of the vehicle headrest 124 according to the present invention. Therefore, in one contemplated embodiment a plurality of snaps 150 may be arranged at predetermined positions along an outer surface of the frame 144 thus allowing the frame 144 to be secured to the outer surface trim of the vehicle headrest 124. It should be noted that the vehicle headrest 124 may include a receiving aperture or member for receiving any snap features, push pins or the like from the headrest storage pocket frame 144. It is also contemplated that the frame 144 is welded, glued, or secured via any other known chemical fastening technique to the rear surface of the vehicle headrest 124. Therefore, any known mechanical or chemical fastening technique may be used to secure the vehicle headrest storage pocket frame 144 to the rear portion of the vehicle headrest 124. The rear cover material 140 of the vehicle headrest 124 and the side cover material 142 of the vehicle headrest 124 are joined to one another via a join seam 136 and a deck seam 138. The seams generally may run underneath the headrest storage pocket frame 144. It should be noted that the headrest storage pocket frame 144 may only extend a predetermined distance up the first and second back side edges of the vehicle headrest 124. The distance that it extends may determine the size of the headrest storage pocket 120 arranged in the rear surface of the vehicle headrest 124. It should further be noted that a plurality of hooks 148 may be arranged at different positions on the inner surface of the headrest storage pocket frame 144 in order to have the netting 132 secured over the hooks 148 at predetermined intervals or positions along the inner surface of the headrest storage pocket frame 144. It should further be noted that the netting 132 may be made of any known material other than the webbing material that generally has elastic properties therein. Therefore, any other known plastic material, composite material, rubber material, metal material, man made material or natural material may be used to form the webbing pocket, the band and the frame for any of the embodiments disclosed herein.

Yet another embodiment of the present invention may include a flap 252 secured to a rear surface of the vehicle headrest 224. Like numerals indicate like parts. In one contemplated embodiment, a flap 252 may be secured on a bottom edge thereof to a bottom edge of the rear surface of the vehicle headrest 224 via any known fastening technique, such as any known mechanical fastening technique or chemical fastening technique. In one contemplated embodiment, a join seam 236 and a deck seam 238 may be used to secure the bottom edge of the flap 252 to the rear bottom edge of the vehicle headrest 224. The flap 252 of the vehicle headrest 224 may include a cover material 254 arranged on the outside of the flap 252, such that the cover material 254 matches the outer cover material 26 of the vehicle headrest 224. A stiffener 256 may be in contact with the cover material 254 on one side of the cover material 254. The stiffener 256 may be made of any known stiff material such as but not limited to plastic, metal, composite, any man-made material, or any natural material. The flap 252 may also include a liner material 258 in contact with the stiffener 256 on the side opposite that of the cover material 254. Therefore, the stiffener 256 is sandwiched between the liner material 258 on one side and the cover material 254 on the opposite side. It should be noted that the stiffener material, cover material and liner material, which all make up the flap 252, may have any known shape. However, the shape may mimic that of the back rear surface of the vehicle headrest 224, such that the pocket 220 is able to be pulled away from the rear surface of the vehicle headrest 224 thus forming a pocket 220 between the rear surface of the vehicle headrest 224 and the flap 252 allowing for storage of material and devices within the pocket 220. A binding member 260 may be arranged along a first side edge, top edge and second side edge of the flap 252. The binding member 260 generally may have a C or U shaped when viewed in cross section. This may allow for some or all of the edges of the stiffener 256, liner material 258 and cover material 254, which form the flap 252, to be covered by the binding member 260 on the edge thereof. Furthermore, the binding member 260 is then connected to the three members making up the flap 252 via a binding sewn seam 262. The binding sewn seam 262 may run along the entire length of the binding member 260, thus securing the binding member 260 to each of the liner material 258, stiffener 256 and cover material 254. Hence, the binding seam 262 passes through the binding member 260 twice and once through the liner material 258, stiffener 256 and cover material 254 along the length of the sewn binding seam 262. It should be known that any type of thread may be used for any of the seams discussed herein. It should further be noted that the stiffener 256 and liner material 258 may each have a first and second orifice 264 arranged therethrough at or near a top surface thereof. This first and second orifice 264 may have a first and second grommet 266 arranged therein. Hence, the first grommet 266 may be arranged between the liner material 258 and stiffener 256 through the orifices 264 described above and a second grommet 266 may be arranged between the liner material 258 and the stiffener 256 through the second orifices 264 described above. This may allow for a cord 268 to be arranged through the first grommet 266 and the second grommet 266 of the flap 252 of the headrest storage pocket 220. It should be noted that the cord 268 generally is made of an elastic material, such as a shock cord, and that the cord 268 may be circular in cross section or may be any other shaped cord, not just a circular cross sectional cord, depicted in the drawings. Therefore, the cord 268 may extend out of a rear portion of the flap 252 wherein the rear portion is directly adjacent to the rear surface of the vehicle headrest 224. The vehicle headrest 224 may include in this embodiment a second stiffener member 270 arranged within a rear surface of the vehicle headrest 224. The second stiffener 220 may be arranged near the outer surface of the cover material 226 on the rear portion of the vehicle headrest 224. The second stiffener 270 may also include a first and second orifice 272 arranged therethrough wherein the first and second orifice 272 align with the orifices 264 of the liner material 258 and stiffener 256 of the flap 252. It should further be noted that the second stiffener 270 may be of any known shape depending on the shape of the vehicle headrest 224 being used thereon. This embodiment also may include a grommet 274 arranged between the second stiffener 270 and the outer cover material 240 of the vehicle headrest 224 and a second grommet 274 arranged between the second stiffener 270 and the outer surface rear cover material 240 of the vehicle headrest 224. The grommets 274 may be aligned directly across from the grommets 266 arranged through the flap 252 of the headrest storage pocket 224. It should be noted that these grommets may be made of any known material, such as a metal, hard plastic, soft plastic, composite, man made material or any natural material. The grommets 266, 274 discussed herein generally are shaped such that they each have a circumferential lip arranged on each end thereof, wherein the circumferential lip may engage with the first stiffener and second stiffener and the liner material and the outer surface of the rear cover material of the headrest 224, respectively. The cord 268 ends that extend from the rear surface of the flap 252 may be arranged through the first and second grommets 274 in the vehicle headrest 224 and then may be connected to the second stiffener 270 via any known fastening technique. As shown in the drawings, the cord 268 may be looped around a first and second hook or eyelet 276 which are secured to the second stiffener 270 on a surface thereof. It should also be noted that the cord 268 may include a crimp clamp 278 on a first and second end thereof, wherein the crimp clamp 278 may form a loop which is used to hook around the first and second hook 276 arranged on the second stiffener 270 in order to secure the cord 268 between the flap 252 and the vehicle headrest 224. In one contemplated embodiment, the cord 268 has enough tension and play thereon such that the flap 252 may engage with the rear surface of the vehicle headrest 224 in a home or non-use position and then the cord 268 may extend via its elastomeric and spring like properties when the user pulls back on the flap 252 and inserts objects to be stored within the vehicle headrest storage pocket 220. It should be noted that the grommets 266 may be arranged anywhere along, near or at the top edge of the flap 252, however in the embodiment shown the grommets 266 are arranged near the outer top edges of the flap 252 thus allowing for the largest storage pocket area for objects therein. Furthermore, it should be noted that any other fastening technique for the ends of the cord 268 may be used other than those described herein.

Still another embodiment of the present invention may include a flap 352 secured to a rear surface of the vehicle headrest 324. Like numerals indicate like parts. This embodiment is similar to the embodiment described above in that a binding member 360 is secured to the side edges and top edge of a flap 352, wherein the flap 352 includes a liner material 358, a stiffener 356 and an outer cover material 354. Hence, the flap 352 is the same as that described above. The flap 352 also includes the orifices 364 described above arranged at or near the same location. However, the orifices 364 of this embodiment do not include a grommet arranged therethrough. In this embodiment a band or cord 380 is arranged through the orifices 364 of the stiffener 356 and liner material 358 on both edges thereof, such that the band 360 may extend from a back or open portion of the flap 352. It should be noted that the cord 380 in this contemplated embodiment is made out of an elastic material, however any other known band, cord, rope, made of any known material other than elastic material, such as but not limited to rubber, composite, natural material, man made material may also be used for the cord 380 of the present invention. The flap 352 may also include a first band 382 arranged on a first side thereof and a second band 384 arranged on a second side thereof, wherein the bands extend from the top edge of the flap 352 to the bottom edge of the flap 352 on both the first and second side of the flap 352. One end of the first band 382 and second band 384 may be secured to the rear surface of the headrest 324 at a join seam 336 and deck seam 338 thereof as described above. The second end of the first band 382 and the second band 384 may be secured to the binding member 360 of the flap 352 wherein the second ends are arranged between an inside surface of the binding member 360 and an outer surface of the liner material 358 on each side of the pocket 352. This may allow for the bands 382, 384 to form a complete pocket with sides between the vehicle headrest 324 rear surface and the flap 352. It should be noted that a join seam 386 may connect the cord 380 to a generally mid-point of the first band 382 and second band 384. The first end of the cord 380 may be connected to the first band 382 at or near a generally midpoint of the first band 382 and the second end of the cord 380 may be connected at or near a generally mid-point of a second band 384 of the vehicle headrest storage pocket 320. It should be noted that the cord 380 in the present invention may be a flat cord, a round cord or any other shaped cord depending on the design requirements of the headrest storage pocket 320. It is also contemplated that the first band 382 and second band 384 may be split into two parts, wherein the first part of the first band 382 is connected to the vehicle headrest 324 along the rear seam thereof while the second part of the first band 382 is connected to the binding member 360 and then both ends of the first part and second part are joined to the first end of the cord 380 via join seam 386 as shown in the figures. Hence, the first and second band may either be one piece or two pieces depending on the design requirements of the present invention.

In operation, the vehicle headrest cover 28 is sewn such that it includes the components of the headrest pocket storage 20 therein. After the headrest cover material 26 is sewn, including the pockets described herein, that headrest cover material 26 is arranged over the frame and padding of the headrest 24 and then placed onto the vehicle seat back according to the present invention. It should be noted that any other type of fasteners or pockets may be used according to the present invention. It should be noted that it does not have to be a webbed pocket and/or a solid flap. Any other known pocket may be sewn onto the rear portion of the vehicle seat or any other type of flap may be sewn and secured to the rear vehicle seat headrest with any type of cord members, etc., arranged thereon.

The present invention has been described in an illustrative manner. It is to be understood that the terminology which has been used is intended to be in the nature of words of description rather than that of limitation.

Many modifications and variations of the present invention are possible in light of the above teachings. Therefore, within the scope of the appended claims, the present invention may be practiced otherwise than as specifically described herein.

What is claimed is:

1. A headrest storage pocket for use in a vehicle seat, said headrest storage pocket comprising;
a pocket made of netting, said pocket is attached to a rear surface of a headrest of the vehicle seat; and
an elastic band attached to a top edge of said pocket.

2. The headrest storage pocket of claim 1, wherein said pocket having a first side edge, a second side edge, and a bottom edge.

3. The headrest storage pocket of claim 2, wherein said first side edge, said second side edge and said bottom edge are secured to said rear surface of the headrest.

4. The headrest storage pocket of claim 3, wherein said side edges and said bottom edge are secured by being sewn into the headrest.

5. The headrest storage pocket of claim 4, wherein said elastic band on each end thereof is sewn into the headrest and said elastic band is secured to the headrest by a join seam and a deck seam.

6. A headrest storage pocket for use in a vehicle seat, said headrest storage pocket comprises:
a flap connected to a bottom rear portion of a headrest of the vehicle seat;
a stiffener arranged in said flap; and
a cord arranged between said flap and the headrest.

7. The headrest storage pocket of claim 6, wherein said flap having a cover material and a liner material in contact with said stiffener.

8. The headrest storage pocket of claim 6 wherein said flap having a binding member arranged over an end of said flap; a binding seam arranged through said binding member, said liner material, said stiffener and said cover material.

9. The headrest storage pocket of claim 8 further comprising a first band and a second band, said first band is arranged between the headrest and said flap, said second band is arranged between the headrest and said flap.

10. The headrest storage pocket of claim 9, wherein said cord on a first end is secured to a generally midpoint of said first band, said cord on a second end is secured to a generally midpoint of said second band, said cord is arranged through orifices of said stiffener and said liner material.

11. The headrest storage pocket of claim 8 further comprising a second stiffener arranged in the headrest, a first and second grommet in contact with said second stiffener on a first end and a headrest cover material on a second end thereof.

12. The headrest storage pocket of claim 11 wherein said flap having a third and fourth grommet, said third and fourth grommet in contact with said liner material on a first end thereof and said stiffener on a second end thereof.

13. The headrest storage pocket of claim 12 wherein said cord is arranged through said first, second, third and fourth grommet.

14. A headrest storage pocket for use on a vehicle seat, said headrest storage pocket comprising:
a generally U-shaped frame, said frame is connected to a headrest of the vehicle seat;
a webbed pocket connected on an inside surface of said frame; and
a band arranged at a top edge of said pocket.

15. The headrest storage pocket of claim 14 wherein said frame having a heat stake arranged on said inside surface thereof.

16. The headrest storage pocket of claim 15 wherein said frame having a retaining fastener, said retaining fastener secures said frame to the headrest.

17. The headrest storage pocket of claim 14 wherein said frame is arranged along a bottom edge, a first edge and a second edge of the headrest.

18. The headrest storage pocket of claim 14 wherein said pocket is connected to said frame along a bottom edge, a first edge and a second edge of said pocket.

19. The headrest storage pocket of claim 14 wherein said band is connected to said heat stake of said frame.

20. The headrest storage pocket of claim 14 wherein said netting is arranged over a hook, said hook is arranged on said inside surface of said frame.
